(19) United States
(12) Patent Application Publication
(10) Pub. No.: US 2014/0356523 A1
(43) Pub. Date: Dec. 4, 2014

(54) MATERIALS, METHODS, AND APPARATUS FOR IMPROVING LEAK ROBUSTNESS

(71) Applicant: GM GLOBAL TECHNOLOGY OPERATIONS LLC, Detroit, MI (US)

(72) Inventor: DEREK W. FULTZ, ROYAL OAK, MI (US)

(73) Assignee: GM GLOBAL TECHNOLOGY OPERATIONS LLC, Detroit, MI (US)

(21) Appl. No.: 14/189,884

(22) Filed: Feb. 25, 2014

Related U.S. Application Data
(60) Provisional application No. 61/828,598, filed on May 29, 2013.

(51) Int. Cl. H01M 2/02; H01M 2/08

(52) U.S. Cl. CPC H01M 2/0262; H01M 2/0292; H01M 2/08; H01M 2220/20
USPC 427/58

(57) ABSTRACT

Materials, methods, and apparatus for improving the ability of an enclosure, such as a battery enclosure, to resist leakage/ingress of water or other liquids. Some embodiments and implementations may be particularly useful in connection with vehicle battery enclosures for electric vehicles, including hybrid electric vehicles. In some implementations, a surface energy of at least a portion of a battery enclosure of an electric vehicle may be lowered by impregnating at least a portion of the battery enclosure with a lower surface energy material, coating at least a portion of the battery enclosure with a hydrophobic coating, and/or roughening a surface of at least a portion of the battery enclosure.

### RELATED APPLICATIONS

This application claims the benefit of priority under 35 U.S.C. §119(e) to U.S. Provisional Patent Application No. 61/828,598, filed May 29, 2013 and titled “MATERIALS, METHODS, AND APPARATUS FOR IMPROVING LEAK ROBUSTNESS,” which application is hereby incorporated by reference herein in its entirety.

### TECHNICAL FIELD

This disclosure relates to materials, methods, and apparatus for improving the ability of an enclosure, such as a battery enclosure, to resist leaks. For example, in some embodiments and implementations, this disclosure relates to materials, methods, and apparatus for improving the water leak robustness of a battery enclosure for an electric vehicle battery.

### BACKGROUND

Current battery pack enclosures are often leak tested to ensure robustness against ingress of water and other liquids. Such tests may involve pressurization of the enclosure with air or helium. Leaks may then be identified by detecting volumes of air or helium that may escape from the enclosure. This may be done with helium detection equipment. Alternatively, a loss of air pressure may be detected by use of a mass flow meter located upstream of where the test gas enters the battery enclosure. These tests often use empirically-established gas leak rate values as pass/fail criteria to determine if a battery pack is sufficiently water tight under a pre-specified depth of water.

Many battery enclosures have stringent leak avoidance requirements that may be difficult and/or expensive to achieve. A desire to avoid water leakage also often leads to tight manufacturing tolerances which may further add expense. In addition, many current leak tests are prone to producing “false failures.” In other words, since some holes/openings in a battery enclosure may be sufficient to allow for air or another gas to pass therethrough, but not sufficiently large to allow water or another liquid to pass, detection of a threshold amount of air or helium, for example, does not always accurately indicate that a battery enclosure is prone to water leakage.

The present inventors have therefore determined that it would be desirable to provide materials, methods, and apparatus that overcome one or more of the foregoing limitations and/or other limitations of prior art.

### SUMMARY

Materials, methods, and apparatus are disclosed herein for improving the ability of an enclosure, such as a battery enclosure, to resist leakage/ingress of water or other liquids. Some embodiments and implementations may be particularly useful in connection with vehicle battery enclosures for electric vehicles, including hybrid electric vehicles.

In an example of an implementation of a method for improving the ability of an electric vehicle battery enclosure to resist liquid leakage, the method may comprise decreasing a surface energy of at least a portion of a battery enclosure of an electric vehicle by at least one of impregnating the at least a portion of the battery enclosure with at least one material comprising a lower surface energy than any other material making up the battery enclosure, coating the at least a portion of the battery enclosure with a hydrophobic coating, and roughening a surface of the at least a portion of the battery enclosure to decrease the surface energy of the at least a portion of the battery enclosure. It should be understood that “decreasing a surface energy” may encompass both steps and processes that reduce the surface energy of one or more surfaces and/or materials, and steps and processes, such as surface roughening, that may decrease the effective surface energy of certain portions of the material so as to inhibit passage of liquids through a defect, hole, opening, etc. In other implementations, any one of these steps, or a subset of these steps, may be performed without performing the other steps and/or all of the steps.

For example, substantial improvements to the ability of an enclosure to resist leakage may be achieved by simply roughening a surface or surfaces of a channel, groove, seal, lining, or other opening may improve the ability of such surface(s) to inhibit fluid travel therethrough. Similarly, in some embodiments and implementations, dopants may be used to decrease surface energy without surface roughening or providing a coating on one or more portions of an enclosure, such as a tray, cover, connector, and/or seal, or such portion(s) may otherwise be manufactured with materials configured to decrease surface energy and thereby improve leak resistance. Likewise, some embodiments and implementations may involve application of a hydrophobic coating and/or another coating configured to decrease surface energy without any dopants or surface roughening. Of course, it is anticipated that the most improvement in leak inhibition may be achieved by utilizing appropriate dopants or otherwise adding materials during initial manufacturing of an enclosure, surface roughening, and adding a hydrophobic coating.

In some implementations, the step of decreasing a surface energy of at least a portion of a battery enclosure for an electric vehicle may comprise impregnating the at least a portion of the battery enclosure with a hydrophobic fluoropolymer material, such as at least one of polytetrafluoroethylene and fluorinated ethylene propylene for example.

In some implementations, the step of decreasing a surface energy of at least a portion of a battery enclosure for an electric vehicle may comprise applying a hydrophobic coating to the at least a portion of the battery enclosure. In some such implementations, the hydrophobic coating may comprise at least one of polytetrafluoroethylene (PTFE), fluorinated ethylene propylene (FEP), a silicone polymer, and a perfluoropolyether.

In some implementations, the battery enclosure may comprise a rubber seal, such as a rope seal. In some such implementations, the step of decreasing a surface energy of at least a portion of a battery enclosure for an electric vehicle may comprise impregnating the rubber seal to decrease a surface energy of the rubber seal.

One or more of the methods disclosed herein may further result in increasing a hole size tolerance in a manufacturing assembly process, such as a manufacturing assembly process for battery enclosures for electric vehicles, as a result of decreasing a surface energy of at least a portion of the battery enclosure. In some implementations, such tolerances may be increased by a factor of at least about three. In some such implementations, such tolerances may be increased by a factor of at least about six.

In another example of an implementation of the invention, a method for improving the ability of an enclosure to resist liquid leakage may comprise obtaining an enclosure comprising at least one sealing interface; and decreasing a surface energy of at least a portion of the enclosure by impregnating at least a portion of the sealing interface of the enclosure with a material configured to reduce a surface energy of the at least a portion of the sealing interface. In some such implementations, the surface energy of the at least a portion of the sealing interface may be decreased to at least about 30 mJ/m². In some such implementations, the surface energy of the at least a portion of the sealing interface may be decreased to at least about 20 mJ/m². In some such implementations, the surface energy of the at least a portion of the sealing interface may be decreased to at least about 10 mJ/m².

In some implementations, all of the material making up the enclosure may be treated by way of, for example, surface roughening, impregnating, coating, or otherwise treating the material according to the principles disclosed herein.

In some implementations, the step of decreasing a surface energy of at least a portion of the enclosure, such as a battery enclosure, may comprise impregnating one or more entire rope seals with a material configured to reduce a surface energy of the rope seal(s). In some such implementations, the step of decreasing a surface energy of at least a portion of the enclosure may comprise impregnating the entire rope seal with a hydrophobic fluoropolymer.

As mentioned elsewhere, some implementations may further, or alternatively, comprise coating at least a portion of the enclosure with a hydrophobic coating and/or roughening a surface of at least a portion of the enclosure to decrease a surface energy of the at least a portion of the enclosure. The at least a portion of the enclosure that is coated and/or surface roughened may comprise a portion of the enclosure exclusive of the sealing interface.

In another particular example of a method according to another implementation, a method for improving the ability of a battery enclosure for a rechargeable energy storage system for an electric vehicle to resist liquid leakage may comprise obtaining a battery enclosure for a rechargeable energy storage system for an electric vehicle. The battery enclosure may comprise at least one sealing interface. Material making up the sealing interface may be impregnated with a material configured to decrease a surface energy of the sealing interface. Such material may comprise, for example, a hydrophobic fluoropolymer that may result in a decrease of a surface energy of the sealing interface to at least about 10 mJ/m². One or more of the implementations disclosed herein may result in a hole size tolerance increase in a manufacturing assembly process, such as a manufacturing assembly process for battery enclosures for rechargeable energy storage systems for electric vehicles.

In some implementations, existing battery enclosures or other enclosures may be improved by way of one or more of the principles, steps, etc., disclosed herein. In other implementations, one or more such principles, steps, etc. may be implemented during an initial manufacturing process of the enclosures.

### BRIEF DESCRIPTION OF THE DRAWINGS

Non-limiting and non-exhaustive embodiments of the disclosure are described, including various embodiments of the disclosure with reference to the figures, in which:

FIG. 1 is a graph illustrating the relationships between water contact angles, gas flow rates through holes in an enclosure, and the size of the holes.

FIG. 2 is a flow chart illustrating one implementation of a method for improving the ability of a battery enclosure to resist liquid leakage.

### DETAILED DESCRIPTION

A detailed description of systems and methods consistent with various embodiments of the present disclosure is provided below. While several embodiments are described, it should be understood that disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Embodiments of the materials, methods, and apparatus disclosed herein may be used to eliminate water ingress, or at least improve water ingress susceptibility, into sealed battery packs, such as battery packs for electric vehicles, including hybrid electric vehicles. By doing so, some embodiments and implementations may result in the ability to relax manufacturing tolerances and/or other requirements on end-of-line leak specifications for helium and/or air in an assembly plant.

For example, some embodiments and implementations may be used to improve the function of battery enclosure seals to better prevent ingress of water and/or other liquids. Examples of manufacturing tolerances/requirements that may be relaxed/improved include requirements for flatness of sealing surfaces, seal geometries, and end of line leak check specifications. Such improvements may result in higher acceptable leak rate limits, which may lead to increased throughput because the pass/fail tests may be shorter. Various embodiments and implementations discussed herein may provide for higher pass/fail limits, which may allow for expedited resolution of test results. This, in turn, may also provide for increased manufacturing throughput.

Alternatively, the principles disclosed herein may be applied to simply improve sealed enclosures, such as battery enclosures, without necessarily improving manufacturing tolerances and/or other requirements. In other words, although tolerances may be relaxed by employing one or more of the inventive principles disclosed herein, a better and more robust product may be manufactured by employing these principles, irrespective of whether manufacturing tolerances are also relaxed in the process.

Other embodiments and implementations are contemplated in which the inventive principles disclosed herein may be applied to other systems, such as coolant systems and the like. With respect to either sealed battery enclosures, or other similar enclosures, various embodiments and implementations may be practiced actively (e.g., coatings and/or surface roughening) or passively (e.g., materials, dopants, compositions, composites used to form the enclosure or one or more portions of the enclosure).

As discussed in greater detail below, it is projected that hole size tolerances may be improved by up to three times or more by employing one or more of the inventive principles disclosed herein. In other words, the size of a hole/opening that may be acceptable (to inhibit liquid leakage under expected conditions) may be increased by up to three times or more by decreasing the surface energy of certain surfaces/materials, as disclosed herein.

Similarly, it is projected that an improvement by up to six times or more in flow rate tolerances may be obtained by employing one or more of the inventive principles disclosed herein. In other words, the threshold gas flow rate through holes/openings in an enclosure during a pass/fail test on a production line may be increased by up to six times or more by employing one or more of the inventive principles disclosed herein. In some embodiments and implementations, such as embodiments and implementations using multiple means for decreasing the surface energy of one or more portions of an enclosure, the threshold gas flow rate through holes/openings in an enclosure during a pass/fail test on a production line may be increased by up to ten times or more.

Moreover, the number of “false failures”—i.e., the number of enclosures that are incorrectly rejected as not sufficiently leak proof—may be reduced by employing one or more of the inventive principles disclosed herein. Consequently, manufacturing throughput may be increased and costs decreased by employing one or more of the inventive principles disclosed herein.

Assuming a circular-shaped opening for simplicity, the minimum opening size through which water can pass is governed by a balance of pressures in conjunction with the properties of the material forming the opening. More particularly, the hydrostatic pressure head of the liquid must overcome the capillary pressure associated with the opening.

By applying basic pressure calculations, it is expected that any circular hole above about 30 microns in diameter will leak water. However, this calculation is highly sensitive to the surface energy of the material defining the hole and the surface tension of the water. More particularly, lowering the surface energy at a bond interface (or anywhere else that may be prone to leakage by water and/or other liquids) will increase the contact angle of liquid to the surface.

Since the capillary pressure in a hole correlates with the liquid surface tension and the cosine of the contact angle to the inside surface of the hole, and since the contact angle is directly proportional to the surface energy of the material defining the hole, reducing the surface energy of a sealing interface will increase the capillary pressure. Because a leak will only occur when the hydrostatic pressure head of the liquid overcomes the capillary pressure, increasing the capillary pressure results in an improvement of the hole to resist leakage. And, as alluded to above, the capillary pressure may be increased by lowering the surface energy of the material defining a hole/opening/defect.

In view of the foregoing, various embodiments and implementations of the invention may employ material and/or methods that lower the surface energy of one or more portions of an enclosure, such as, for example, portions adjacent to lids, ports, or other known openings, and/or one or more portions of an enclosure that may be prone to defects that often result in leaks. In some embodiments and implementations, the entire enclosure may be treated, coated or otherwise manufactured to lower the surface energy, as described throughout this disclosure.

Examples of methods/techniques for decreasing the surface energy of one or more portions of an enclosure, such as a sealed battery enclosure for an electric vehicle, include using materials and/or dopants having low surface energies or otherwise configured to lower the surface energy of material(s) making up an enclosure. In other embodiments and implementations, at least a portion of the enclosure may be coated with a hydrophobic coating, or a coating otherwise configured to lower the surface energy of the enclosure. In still other embodiments and implementations, one or more surfaces of the enclosure may be roughened to decrease the surface energy of at least a portion of the enclosure.

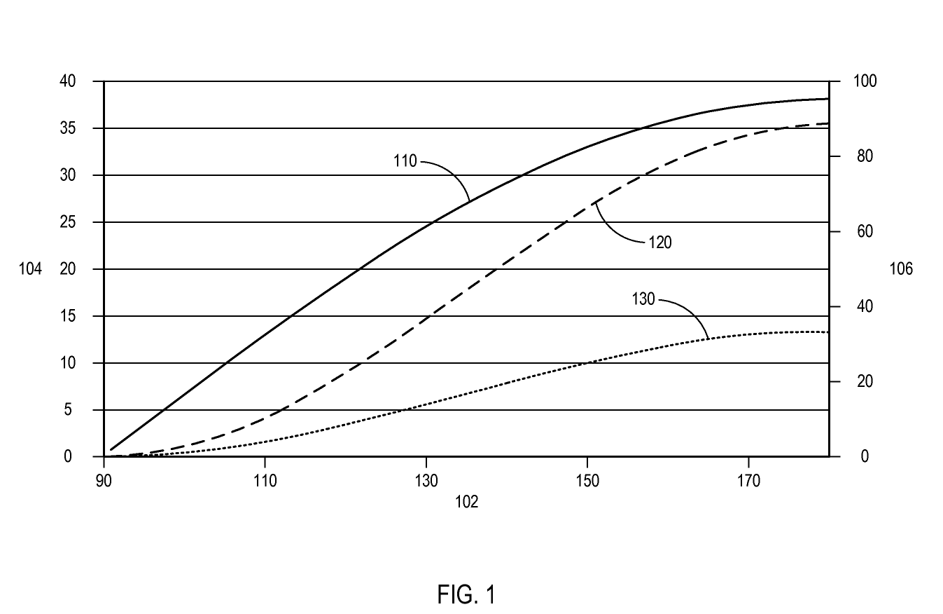

Additional details of the disclosure will now be discussed in connection with the accompanying figures. FIG. 1 depicts a graph illustrating the relationships between water contact angles, gas flow rates through holes in an enclosure, and the size of the holes. The contact angle (in degrees) between liquid water and a solid material defining failure points/openings in a battery enclosure is illustrated along axis 102. A gas flow rate (in standard cubic centimeters per minute) through the openings is illustrated along axis 104. Finally, the sizes of the openings (in microns) are illustrated along axis 106.

Three lines are depicted in the graph of FIG. 1. Namely, line 130 plots the flow rate of air through a failure point/opening, line 120 plots the flow rate of hydrogen gas through a failure point/opening, and line 110 plots the allowable size of a hole/defect in a pass/fail post-manufacturing test to determine if a battery pack enclosure is sufficiently water tight.

As can be seen from comparing these three lines, the contact angle is a key factor in inhibiting water and/or other fluids from entering a sealed enclosure at one or more holes/defects in the material making up the enclosure. Moreover, as mentioned above, lowering the surface energy of materials defining such openings/defects will increase the contact angle. These relationships therefore suggest opportunities for improving the robustness of, for example, sealed battery enclosures, with respect to liquid intrusion by changing the material properties of one or more portion of the enclosure by lowering the surface energy of such portion(s).

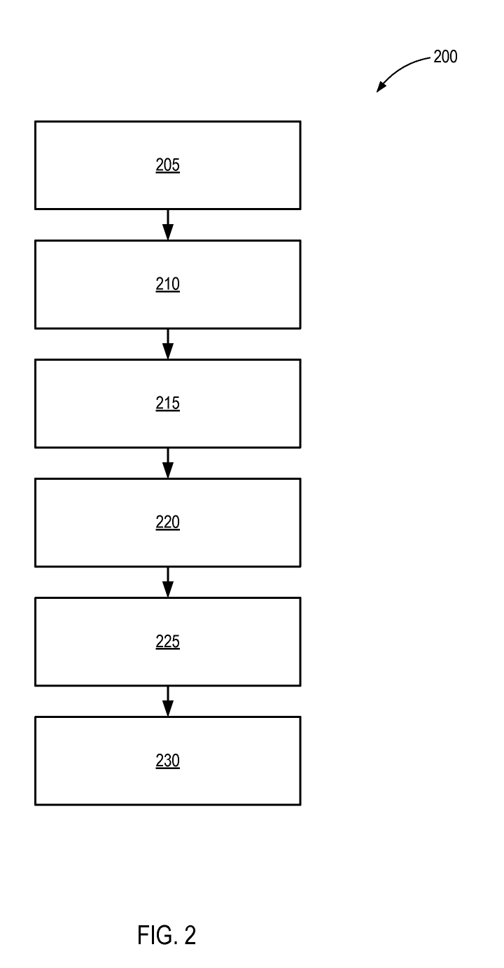

FIG. 2 is a flow chart illustrating one implementation of a method 200 for improving the ability of a battery enclosure, such as a battery enclosure for an electric vehicle, to resist water or other liquid leakage. At step 205, at least a portion of the battery enclosure may be doped, impregnated, or otherwise manufactured with a material configured to lower the surface energy of one or more portions of the battery enclosure. For example, in some implementations, a hydrophobic fluoropolymer material, such as polytetrafluoroethylene (PTFE), fluorinated ethylene propylene (FEP), and the like may be used. Other examples of materials that may be used to decrease surface energy include other fluorocarbons, esters, and dienes, as well as acrylics, amides, imides, ethers, olefins, styrenes, and vinyls (such as vinyl acetals, vinyl chlorides, vinyl esters, vinyl ethers, vinyl keytones, and vinylpyridine). In some implementations, one or more such materials may be used as a dopant and incorporated directly into certain materials making up the enclosure, such as rope seals or other rubber or other polymer seals or an epoxy resin used during the manufacturing process.

In some embodiments and implementations, the surface energy of one or more portions of the enclosure may be reduced to at least about 30 mJ/m². In some such embodiments and implementations, the surface energy of one or more portions of the enclosure may be reduced to at least about 20 mJ/m². In some such embodiments and implementations, the surface energy of one or more portions of the enclosure may be reduced to at least about 10 mJ/m².

At step 210, one or more coatings may be applied that are configured to decrease a surface energy of at least a portion of the battery enclosure. In some implementations, low surface energy coatings such as polytetrafluoroethylene (PTFE), fluorinated ethylene propylene (FEP), silicone polymers, perfluoropolyethers, and the like may be used. Such coatings may be applied by, for example, extrusion, spin-coating, dip-coating, chemical vapor deposition (CVD), physical vapor deposition (PVD), atomic layer deposition (ALD), chemical vapor infiltration (CVI), spray pyrolysis, and the like.

At step 215, one or more portions of a surface of at least a portion of the battery enclosure may be roughened to further decrease the surface energy of the battery enclosure, or at least certain portion of the battery enclosure. For example, preferably regions that are adjacent to any openings, lids, seals and/or other sealing interfaces, etc., are surface roughened. Increasing the surface roughness may be accomplished by, for example, grinding, micromachining, laser etching, laser texturing, sand or other abrasive blasting, chemical etching, thermal etching, and the like. In alternative embodiments and implementations, increasing the surface roughness may be accomplished via use of a sacrificial pore former that may be driven off using evaporation and/or carbonization in a subsequent process. Such processes may result in a micro/nano scale surface roughness.

At step 220, a second coating may be applied to one or more portions of the battery enclosure. For example, in some implementations, one or more portions of the battery enclosure that had been subjected to the surface roughness increasing process of step 215 may be coated at step 220. Such portion(s) may, in some implementations, have had a previous coating applied at step 210 (which may have been largely removed from the roughening process, for example) or, alternatively, may not have had any previous coating applied.

At step 225, a second surface roughening may be applied. For example, in some implementations, one or more portions of the battery enclosure on which a second coating had been applied at step 220 may undergo a secondary surface roughening step. In some such implementations, the surface roughening step of step 225 may be less vigorous or otherwise remove less material than the surface roughening process of step 215.

At step 230, one or more attachable pieces may be doped or otherwise treated with low surface energy materials, as described above, and/or may be coupled with the battery enclosure. For example, in some implementations, step 230 may comprise doping one or more rubber seals, such as a rope seal, with nanoparticles of a hydrophobic fluoropolymer material, such as polytetrafluoroethylene (PTFE), fluorinated ethylene propylene (FEP), or the like.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. A method for improving the ability of a battery enclosure for an electric vehicle to resist liquid leakage, the method comprising:
decreasing a surface energy of at least a portion of a battery enclosure for an electric vehicle by at least one of:
impregnating the at least a portion of the battery enclosure with at least one material comprising a lower surface energy than any other material making up the battery enclosure;
coating the at least a portion of the battery enclosure with a hydrophobic coating; and
roughening a surface of the at least a portion of the battery enclosure to decrease the surface energy of the at least a portion of the battery enclosure.

2. The method of claim 1, wherein the step of decreasing a surface energy of at least a portion of a battery enclosure for an electric vehicle comprises impregnating the at least a portion of the battery enclosure with a hydrophobic fluoropolymer material.

3. The method of claim 2, wherein the step of decreasing a surface energy of at least a portion of a battery enclosure for an electric vehicle comprises impregnating the at least a portion of the battery enclosure with at least one of polytetrafluoroethylene and fluorinated ethylene propylene.

4. The method of claim 1, wherein the step of decreasing a surface energy of at least a portion of a battery enclosure for an electric vehicle comprises applying the hydrophobic coating to the at least a portion of the battery enclosure, and wherein the hydrophobic coating comprises at least one of polytetrafluoroethylene (PTFE), fluorinated ethylene propylene (FEP), a silicone polymer, and a perfluoropolyether.

5. The method of claim 1, wherein the battery enclosure comprises a rubber seal, wherein the step of decreasing a surface energy of at least a portion of a battery enclosure for an electric vehicle comprises impregnating the rubber seal to decrease a surface energy of the rubber seal.

6. The method of claim 5, wherein the rubber seal comprises a rope seal.

7. The method of claim 1, further comprising increasing a hole size tolerance in a manufacturing assembly process of battery enclosures for electric vehicles as a result of decreasing a surface energy of at least a portion of the battery enclosure.

8. A method for improving the ability of an enclosure to resist liquid leakage, the method comprising:
obtaining an enclosure comprising at least one sealing interface; and
decreasing a surface energy of at least a portion of the enclosure by impregnating at least a portion of the sealing interface of the enclosure with a material configured to reduce a surface energy of the at least a portion of the sealing interface to at least about 30 mJ/m².

9. The method of claim 8, wherein the step of decreasing a surface energy of at least a portion of the enclosure comprises decreasing a surface energy of the at least a portion of the sealing interface to at least about 20 mJ/m².

10. The method of claim 9, wherein the step of decreasing a surface energy of at least a portion of the enclosure comprises decreasing a surface energy of the at least a portion of the sealing interface to at least about 10 mJ/m².

11. The method of claim 8, wherein the at least a portion of the sealing interface comprises a rope seal.

12. The method of claim 11, wherein the step of decreasing a surface energy of at least a portion of the enclosure comprises impregnating the entire rope seal with a material configured to reduce a surface energy of the rope seal.

13. The method of claim 12, wherein the step of decreasing a surface energy of at least a portion of the enclosure comprises impregnating the entire rope seal with a hydrophobic fluoropolymer.

14. The method of claim 8, wherein the enclosure comprises a battery enclosure.

15. The method of claim 14, wherein the enclosure comprises a battery enclosure for a rechargeable energy storage system for an electric vehicle.

16. The method of claim 8, further comprising coating at least a portion of the enclosure with a hydrophobic coating.

17. The method of claim 8, further comprising roughening a surface of at least a portion of the enclosure to decrease a surface energy of the at least a portion of the enclosure.

18. The method of claim 17, wherein the at least a portion of the enclosure comprises a portion of the enclosure exclusive of the sealing interface.

19. A method for improving the ability of a battery enclosure for a rechargeable energy storage system for an electric vehicle to resist liquid leakage, the method comprising the steps of:
obtaining a battery enclosure for a rechargeable energy storage system for an electric vehicle, wherein the battery enclosure comprises at least one sealing interface;
impregnating material making up the sealing interface with a material configured to decrease a surface energy of the sealing interface,
wherein the step of impregnating material making up the sealing interface with a hydrophobic fluoropolymer decreases a surface energy of the sealing interface to at least about 10 mJ/m²; and
increasing a hole size tolerance in a manufacturing assembly process for battery enclosures for rechargeable energy storage systems for electric vehicles as a result of the decrease in the surface energy of the sealing interface.

20. The method of claim 19, further comprising:
coating at least a portion of the battery enclosure with a hydrophobic coating; and
roughening a surface of at least a portion of the battery enclosure to decrease the surface energy of at least a portion of the battery enclosure.
